(19) United States
(12) Patent Application Publication
(10) Pub. No.: US 2011/0094892 A1
(43) Pub. Date: Apr. 28, 2011

(54) ELECTROLYSER

(76) Inventors: Zdenek Cerny, Brampton (CA); Francis Michael Burke, Toronto (CA)

(21) Appl. No.: 12/599,535

(22) PCT Filed: May 10, 2007
(86) PCT No.: PCT/CA07/00837

§ 371 Date: Dec. 20, 2010

(51) Int. Cl. C25B 15/04; C25B 9/08; C25B 9/06; B32B 37/12

(52) U.S. Cl. 205/350; 204/242; 204/275.1; 156/60

(57) ABSTRACT

An electrolyser comprising a stack of electrolysis plates, the plates being maintained in substantial alignment to comprise an electrolysis cell, and a press for applying a compressive force to opposed ends of the cell whereby the press maintains the electrolysis plates in substantial alignment when the electrolyser is in operation.

### FIELD OF THE INVENTION

This invention relates to an assembly for securing and compressing a stack electrolysis cell.

### BACKGROUND OF THE INVENTION

Electrolysis cells have long been used to generate hydrogen from water, generally in the form of an electrolyte solution.

In a particular electrolysis cell, porous anode and cathode plates are arranged in a stack with an electrolyte permeable-gas impermeable membrane placed between each anode and cathode pair (WO2004/020701; CA2,400,775 ELECTROLYZER, Helmke et al., incorporated herein by reference). By providing separate channels to each of the anodes and cathodes, the product gases generated at each of the anodes and cathodes may be separately output from the cell. Electrolyte is circulated through the porous anodes and cathodes. In order to circulate the electrolyte and provide an outlet for the product gases, the channels are created by cutting holes or slots in each plate that align when the plates are stacked. The aligned holes and slots form the channels to circulate electrolyte and provide for output of the product gases.

An advantageous method of manufacturing such a cell has been to stack the anode plates, cathode plates and membranes and encase the resulting stack in an electrolyte impermeable-gas impermeable membrane such as epoxy resin. The epoxy is used to assist in sealing the edges of the plates and to secure the plates in an aligned stack. The resultant electrolyser may thus be comprised of multiple electrolysis cells encased in an epoxy resin casing. Ports may be provided through the epoxy casing to permit circulation of electrolyte and output of the product gases. Electricity may be provided to the cells via an electrical connection that extends out of the epoxy.

While this method of creating an electrolyser from a stack of anode and cathode plates has been successful, it does suffer from some limitations. The resulting electrolysers are limited in their gas output rate as elevated internal pressures cause the epoxy to swell and allow the plates to separate. Once the plates separate, even by a relatively small amount, the channels may no longer be completely separate. Even a small breakdown in channel integrity may result in co-mingling of product gases and electrolyte, reducing output from the electrolyser.

A further limitation of the cells is that the electrolyte circulation ports and product gas output ports are connected to external plumbing via connectors screwed directly into the epoxy. While for light duty applications this may be sufficient, it would be preferable to provide for connectors with higher pull out strength and improved sealing.

Thus, it would be advantageous to provide for a stack cell and a method of manufacturing such a stack cell that alleviates these limitations.

### BRIEF DESCRIPTION OF THE DRAWINGS

In drawings which illustrate embodiments of the invention by way of example only:

FIG. 1a is an isometric exploded view of a stack of electrolysis plates.

FIG. 1b is an isometric view of an assembled electrolysis cell.

FIG. 2 is a simplified isometric view of the assembled electrolysis cell of FIG. 1b with an elastomer layer between two compression plates.

FIG. 3 is an isometric exploded view of an electrolyser according to an embodiment of the invention.

FIG. 4 is an isometric view of a fixture and guide locators as depicted in FIG. 3.

FIG. 5 is an isometric view of a compression plate positioned on the guide locators and fixture of FIG. 4.

FIG. 6a is a further isometric view of the compression plate of FIG. 5.

FIGS. 6b and 6c are a side view cut-away illustration of the guide locators and compression plate of FIG. 6a.

FIG. 7a is an isometric illustration of the compression plate of FIG. 5 having an elastomer layer.

FIG. 7b is an enlarged side view of a guide locator FIG. 7a.

FIG. 8a is an isometric view of a cell positioned over the elastomer layer of FIG. 7a.

FIGS. 8b and 8c are side view cut-away views of the cell and guide locators of FIG. 8a.

FIG. 9 is a side view showing a second compression plate positioned on the cell of FIG. 8a.

FIG. 10 is a side cut-away view of port connectors threaded into a compression plate.

FIG. 11 is an isometric view of an assembled electrolyser according to an embodiment of the invention.

FIG. 12 is an isometric cut-away view of the electrolyser of FIG. 11.

FIGS. 13a and 13b are isometric views of a further embodiment of the invention.

FIGS. 14a and 14b are isometric view illustrations of a further embodiment of a compression plate.

### DETAILED DESCRIPTION OF THE INVENTION

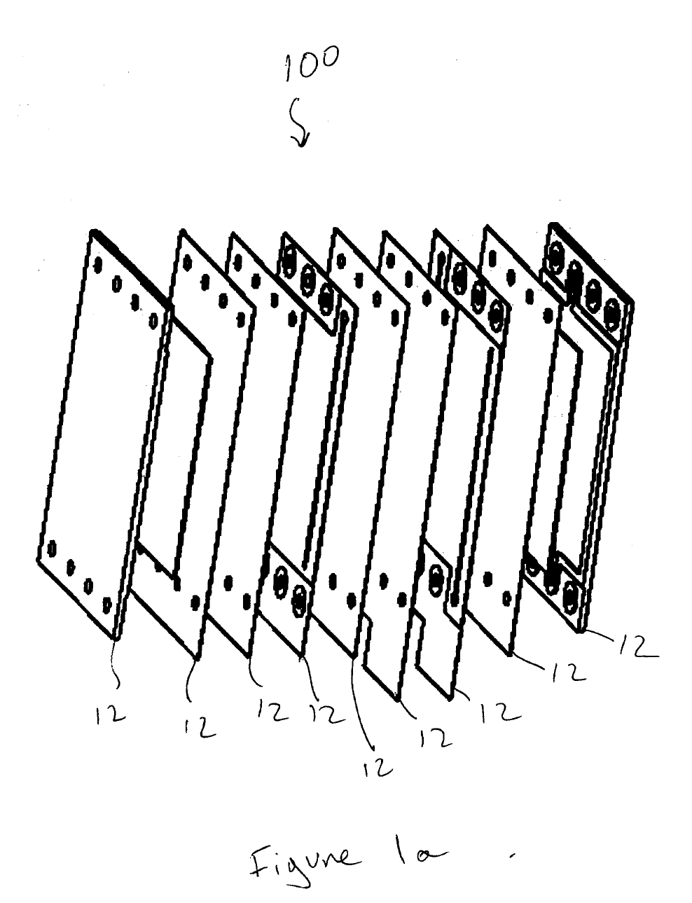

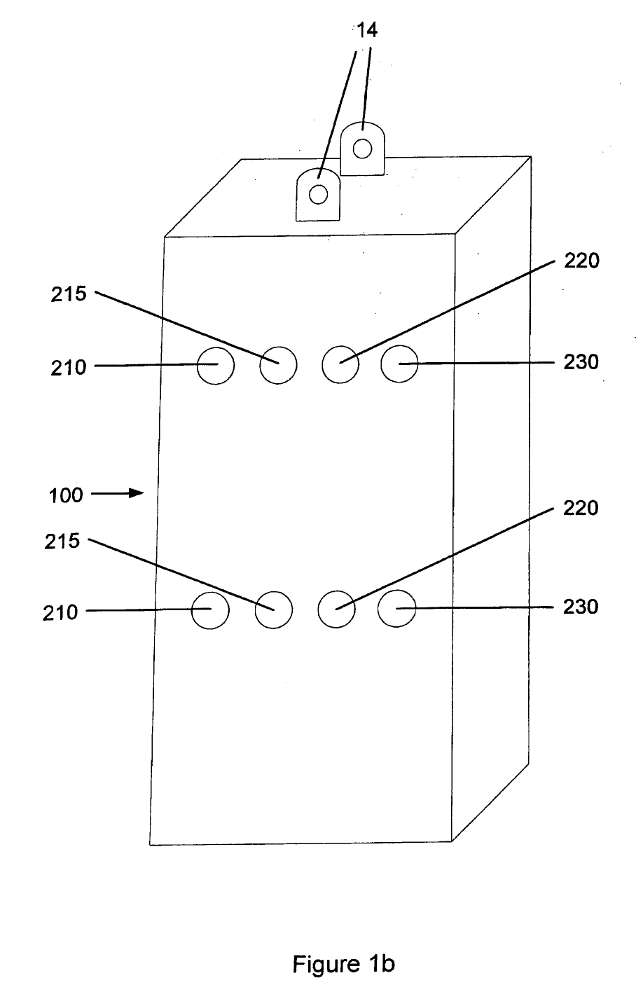

Referring to FIG. 1a an exploded view of a stack 10 of electrolysis plates 12 comprising alternating porous anode and cathode plates with an electrolyte permeable-gas impermeable membrane between each anode-cathode pair. The stack 10 and one embodiment of the electrolysis cell 100 are fully described in WO 2004/02071 and CA2,400,775, which are incorporated herein by reference.

The electrolysis plates 12 may be assembled into the stack 10 and maintained in alignment by encasing the stack 10 in a sealant such as epoxy, a silicone compound or any other suitable sealant, to seal the edges of the plates and maintain the stack 10 in alignment to provide an electrolysis cell 100 as illustrated in FIG. 1b. As described in WO2004/020701 and CA2,400,775, slots in the plates align when stacked to form channels through the stack 10. The channels permit circulation of electrolyte through the stack 10 and output of the product gases from the cell 100. Preferably a first product gas is output from a first set of one or more output ports 210, a second product gas is output from a second set of one or more output ports 215, electrolyte is input through a set of one or more electrolyte input ports 220, and electrolyte is output through a set of one or more electrolyte output ports 230. As will be appreciated, the placement and number of ports may vary from the embodiment illustrated in FIG. 1b.

During operation of the cell 100, a current supplied to electrodes 14 results in hydrogen and oxygen gas being generated in the electrolysis plates 12 of the cell 100. The generation of these product gases increases the internal pressure of the cell 100, causing the product gases to egress through the product gas ports 210, 215. In order to increase the gas output of the cell 100, a higher electrical input may be supplied to the electrodes 14. The higher electrical input results in the product gases being generated more quickly, the internal pressure of the cell 100 increasing and a higher flow rate of product gases from product gas ports 210, 215. It has been found that a cell 100 manufactured as described above has a maximum effective gas output rate before the cell 100 swells and allows product gases and electrolyte to mix within the cell 100.

It has surprisingly been found that a cell 100 may be operated at higher levels of gas output, and subsequent higher internal operating pressures, if a substantially even compressive force is applied to opposite ends of the cell 100 and maintained during operation. It has also been found that accommodation is preferably made for thermal expansion of the cell 100 while under the compressive force. In one embodiment accommodation for thermal expansion of the cell 100 is made by inserting an elastomer layer between the compressive force and at least one end of the cell 100.

In an embodiment, the invention provides an apparatus for securing an electrolyser comprised of a stack of electrolysis plates, the apparatus comprising, a pair of compression plates for locating at opposite ends of the stack of electrolysis plates and, a compression means adapted to engage the plates and urge them towards one another, compressing the cell.

In another embodiment, there is provided an electrolyser comprising a stack of electrolysis plates, the plates being maintained in alignment to comprise an electrolysis cell, and a press for applying a compressive force transversely to opposed ends of the cell whereby the press maintains the electrolysis plates in substantial alignment when the electrolyser is in operation.

Further, the press may comprise a first compression plate for locating at one end of the cell and a second compression plate for locating at the opposed end of the cell and a compression member for acting on the first and second compression plates to apply a compressive force to the cell.

Further, at least one elastomer layer may be positioned between the compression plates and the electrolysis cell. Preferably the elastomer layer is composed of, at least in part, Ethylene Propylene Dieene Monomer.

In an embodiment an elastomer layer is introduced between the compressive force and the cell to allow for thermal expansion or contraction of the cell. Depending upon the material properties of the cell, and the desired range of operating temperatures, it is possible that the cell could swell. In such circumstances, the elastomer layer accommodates the expansion of the cell minimising the risk that the cell might rupture or crack.

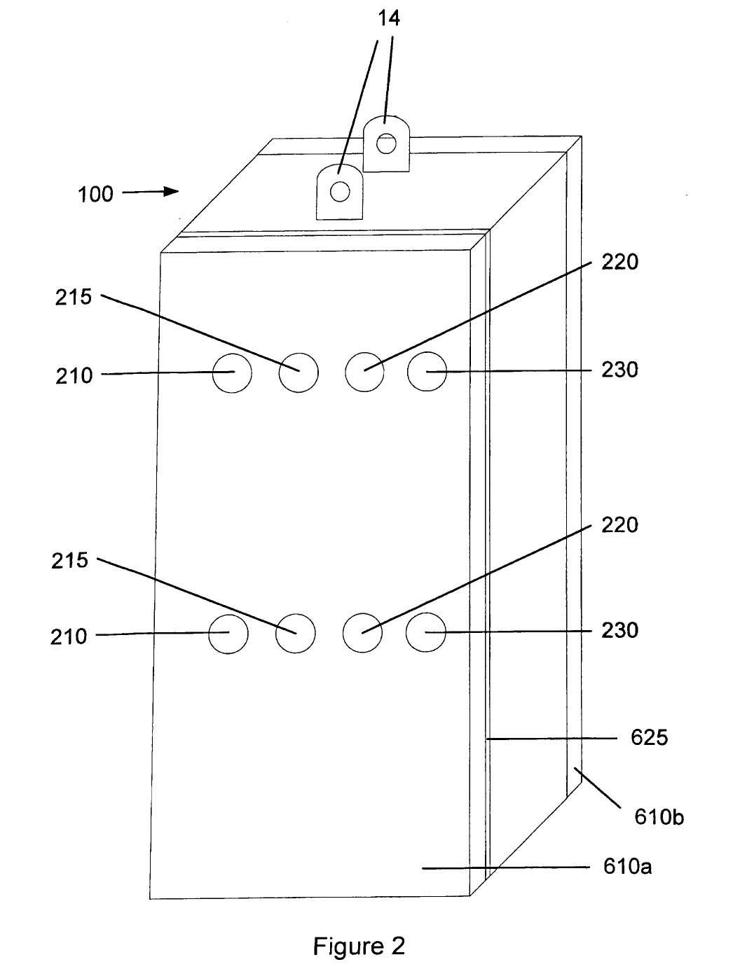

FIG. 2 is a simplified illustration of a cell 100 with compression plates 610 aligned at opposite ends of the stack 100. An elastomer layer 625 is located between the facing compression plate 610a and the stack 100. Compression plates 610 are preferably constructed of a rigid material such as stainless steel, carbon fibre, plastic (including: polyetheretherketon (PEEK), PVC, CPVC), or other suitable material.

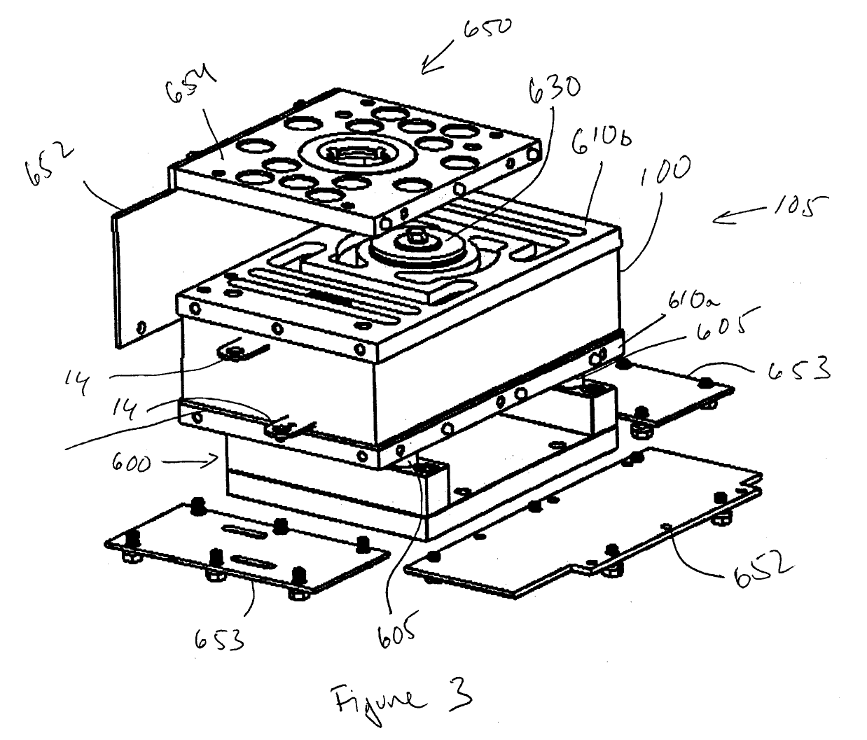

Referring to FIG. 3, an electrolyser 105 may be conveniently assembled on a fixture 600. Preferably guide locators 605 are located on fixture 600 to assist in positioning the cell 100 to align product gas ports 210, 215 and electrolyte ports 220, 230 with holes or ports in at least one compression plate 610.

Preferably a compression plate 610a is first positioned on guide locators 605. Inserts 627, not shown in this view, may also be positioned with the guide locators 605 to align the elastomer layer 625 and an O-ring 627. The cell 100 may then be positioned on the inserts 627 and guide locators 605. An O-ring 627, which may be formed integrally with the elastomer layer 625 about the port openings or installed as a separate component, provides sealed engagement between the product gas ports 210, 215, electrolyte ports 220, 230 and the compression plate 610a. Preferably, as shown, an elastomer layer 625 may also be positioned between the cell 100 and the compression plate 610a. An opposed compression plate 610b may then be positioned on top of the cell 100. Optionally a second elastomer layer 625 may be positioned between the cell 100 and the opposed compression plate 610b. In the embodiment illustrated in FIG. 2, only the bottom compression plate 610a includes openings in communication with ports in the cell 100, and only one elastomer layer 625 is included. Conveniently, in the embodiment illustrated in FIG. 3, elastomer layer 625 in conjunction with O-rings 620 also provide sealing of the electrolyte and product gas ports 210, 215, 220 and 230 at the cell 100 and compression plate 610 interface.

A compression member such as the threaded element 630 illustrated in FIG. 3, a disc spring, or other suitable compression means, engages the compression plates 610 to apply a compressive force to the cell 100.

In the embodiment of FIG. 3, a compression bracket 650 comprising side walls 652 and plate 654 may be conveniently secured to one of the compression plates 610 to allow the compression member to co-operatively engage with the compression plates 610 to apply the compressive force to the cell 100. As will be appreciated, in other embodiments the compression member may interact with the compression plates 610 through other means such as a direct connection.

Alternatively, the compression member may comprise a compression bracket where the compression bracket both engages with the compression plates 610 and applies a compressive force without the need for a separate compression element (not shown). This could be achieved, for instance, where the compression bracket comprises an elastically deformable material that may be elastically deformed under an external force to engage the compression plates 610, and when the external force is removed the compression bracket imparts a compressive force on the compression plates 610.

In an optional arrangement (not shown), one compression plate may comprise an internal wall of a container for housing the cell 100 and a second compression plate 610 may be employed to impart a compressive force to the cell 100 by using a compression member to engage with the second compression plate 610 and another wall of the container. As will be appreciated, in this arrangement a wall of the container comprises a compression plate 610 and at least one other wall of the container comprises the compression bracket 650 for engaging with a compression member 630 to apply a compressive force to the second compression plate 610 and subsequently the cell 100.

Preferably, after assembly of the bracket 650 and application of a compressive force, end walls 653 may affixed in place to provide a protective container for the cell 100.

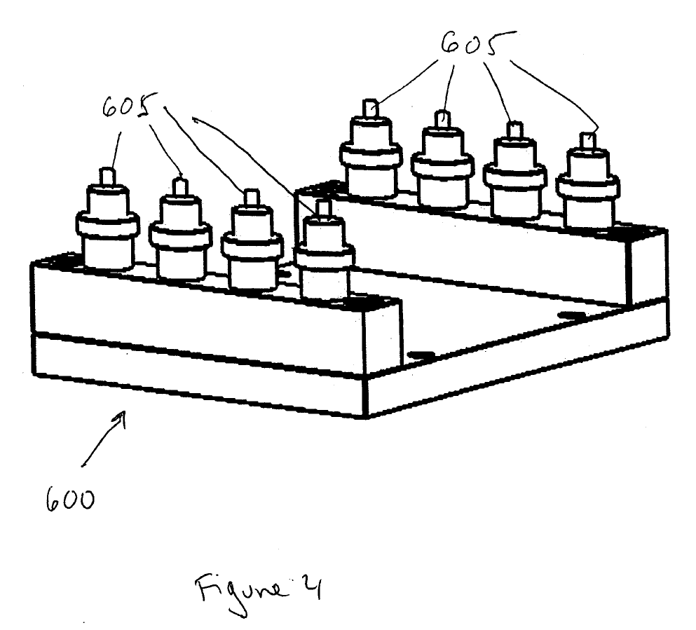

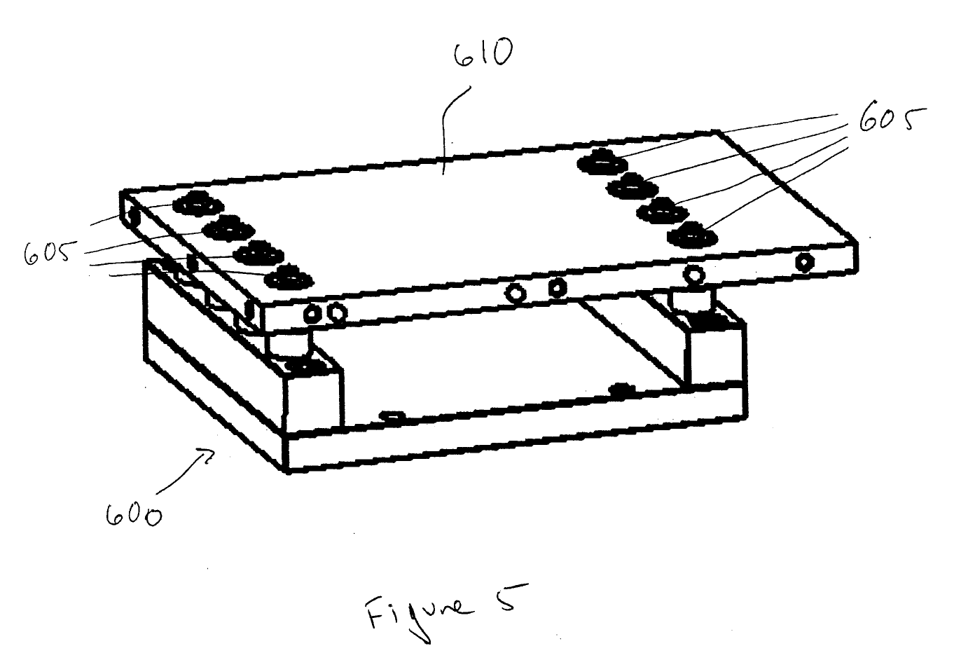

FIG. 4 shows details of the fixture 600 and guide locators 605 depicted in FIG. 3. FIG. 5 in turn shows a compression plate 610a positioned on the guide locators 605. In the embodiment illustrated the compression plate 610a comprises a rigid material, such as stainless steel, and is substantially planar. However, as described above it will be appreciated that the plate may be formed from any other suitable material, and need not be planar but rather can be configured in any fashion that would apply a substantially uniform pressure to the cell 100.

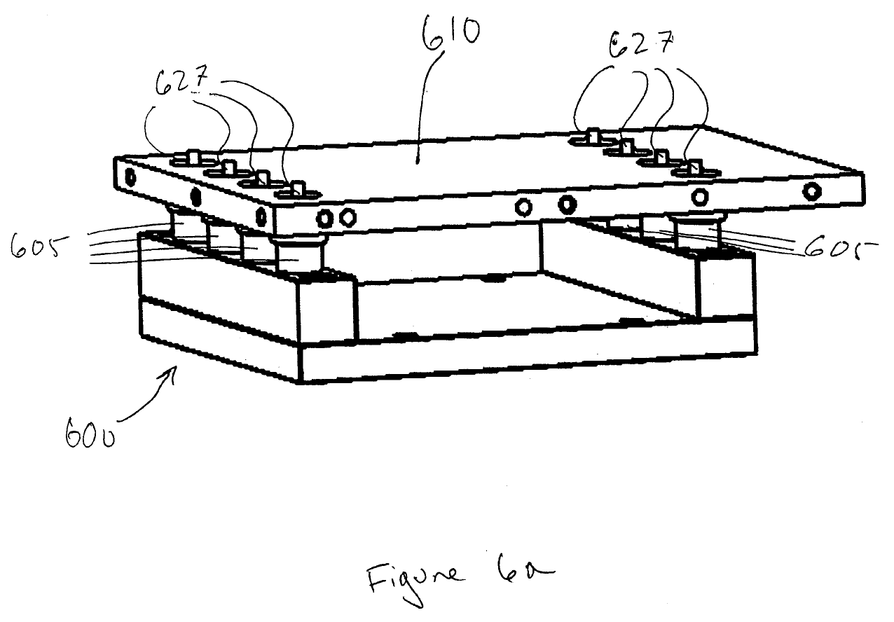

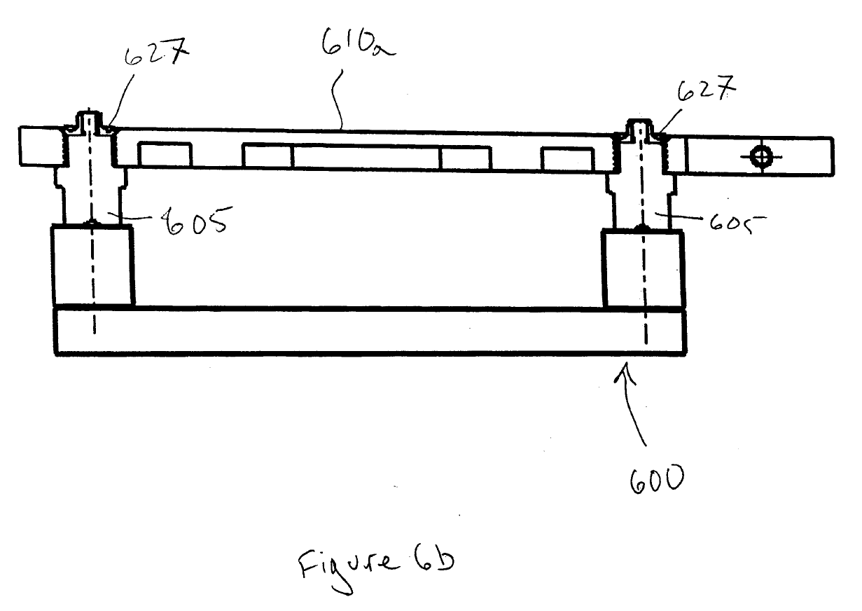

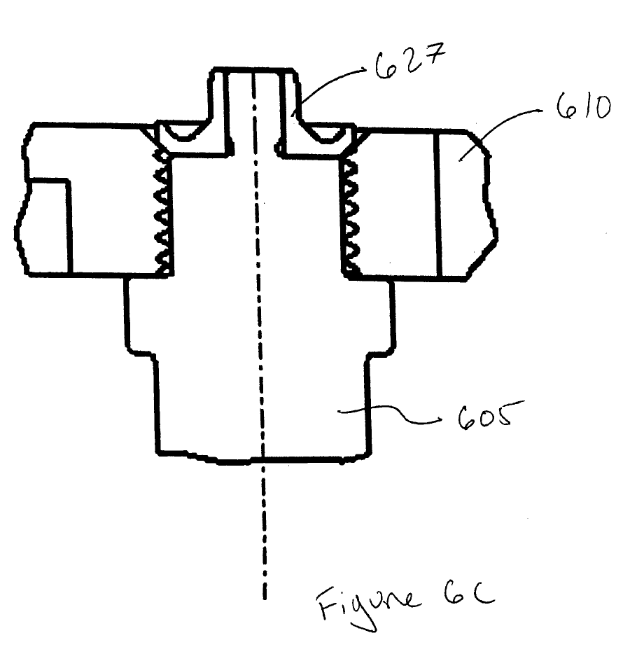

FIG. 6a shows inserts 627 located in the port apertures 615 of the compression plate 610a. Preferably as shown the port apertures 615 are conveniently threaded, to assist in securing input and output connectors in communication with a cell 100. FIGS. 6b and 6c show the inserts 627 positioned in the port apertures 615 of the compression plate 610a on the guide locators 605.

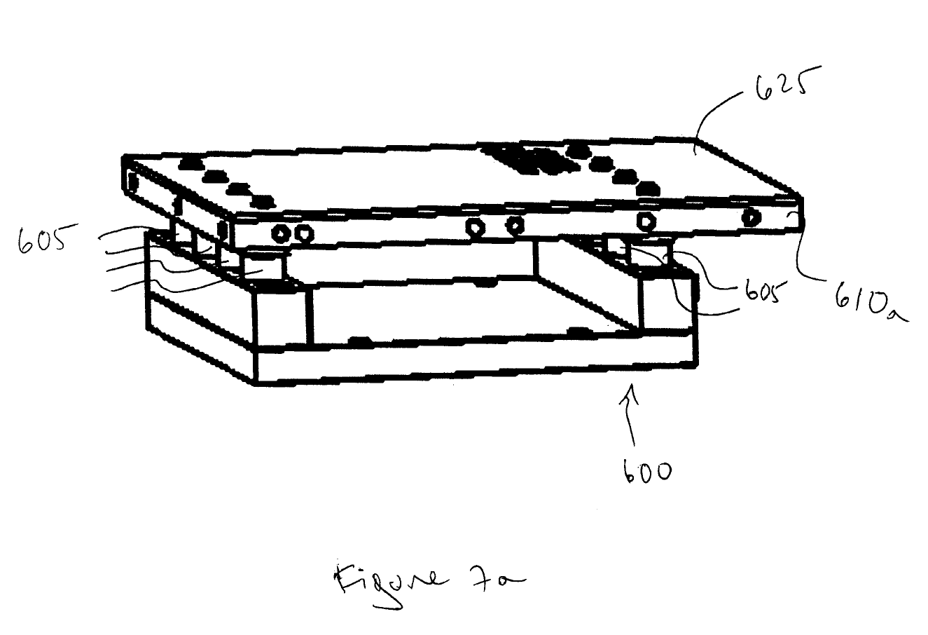

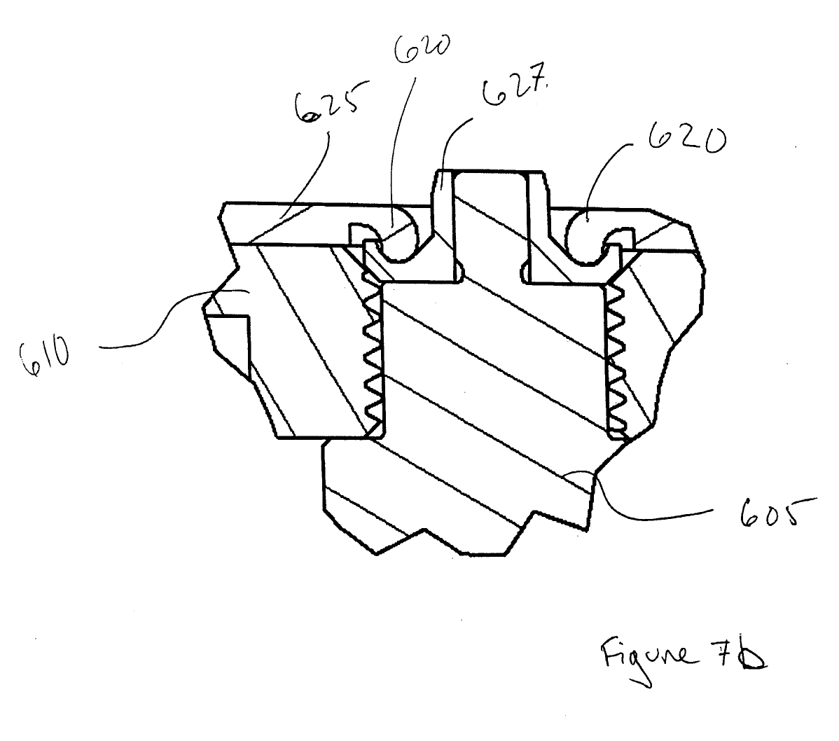

As shown in FIG. 7a, an elastomer layer 625 is positioned on the compression plate 610a with holes in the elastomer layer 625 aligned with the guide locators 605 and O-rings 620. FIG. 7b shows the preferred cooperation between the elastomer layer 625 and each insert 620.

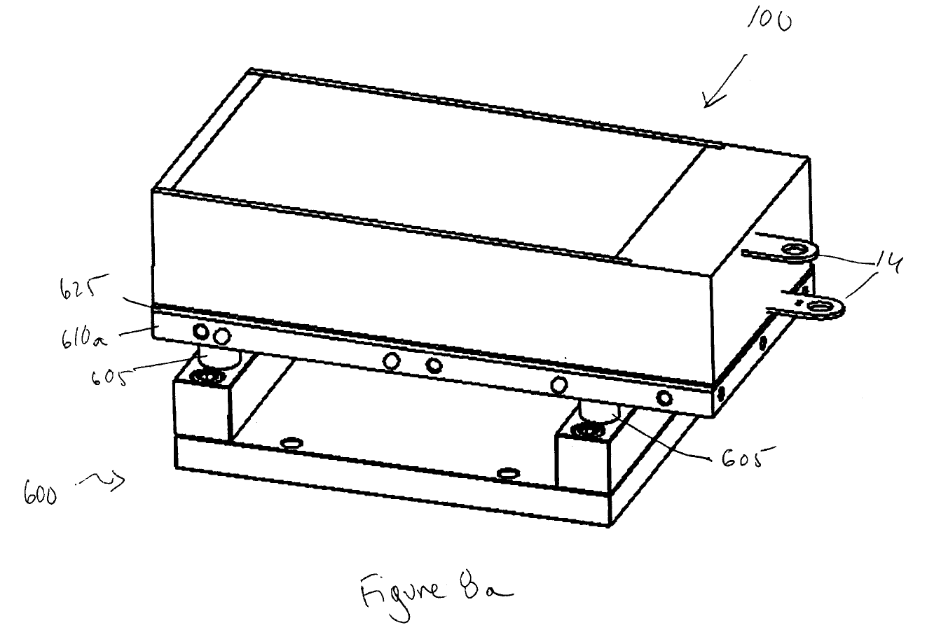

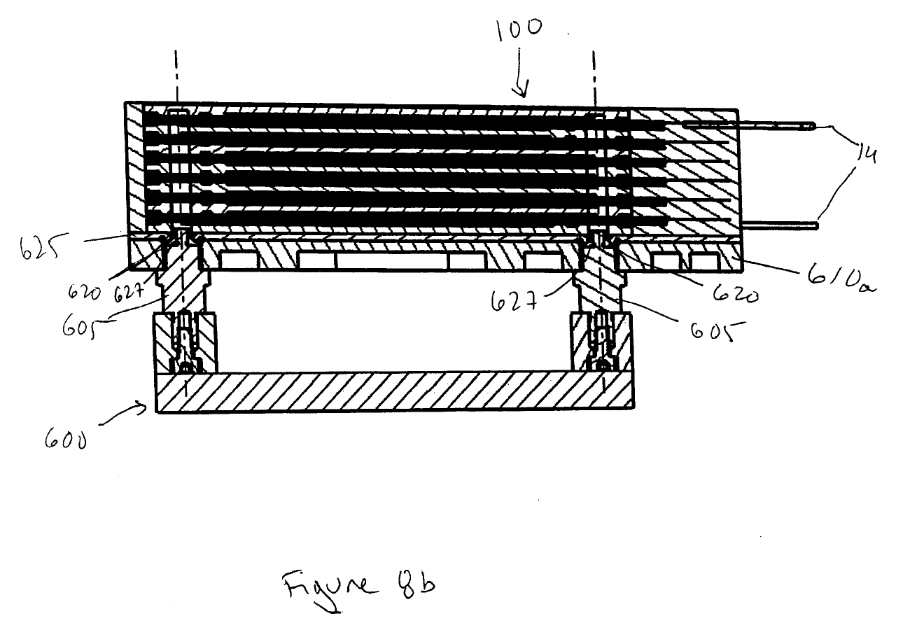

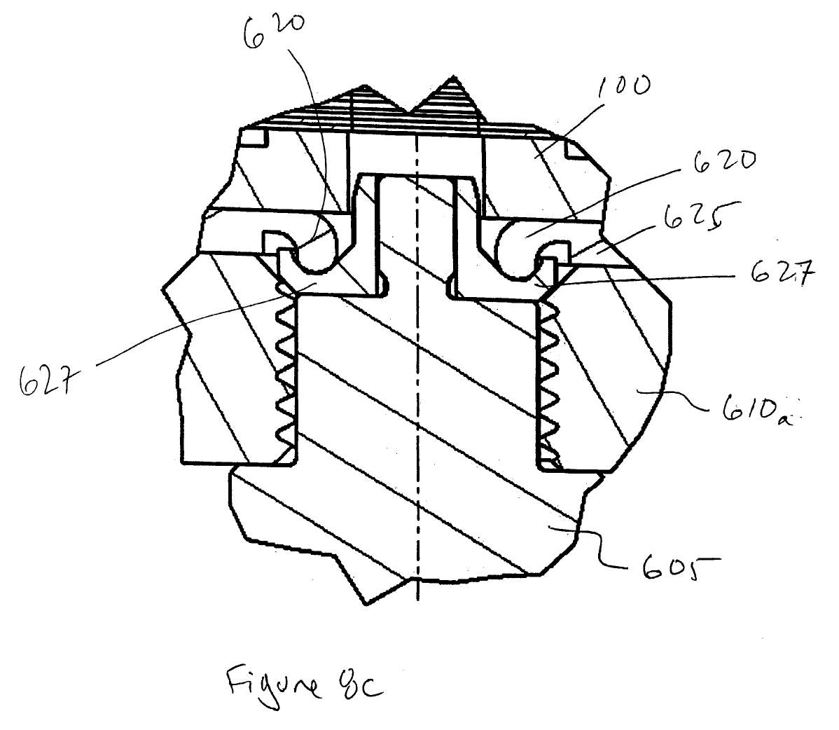

FIG. 8a shows the cell 100 positioned over the elastomer layer 625. FIG. 8b show details of the alignment of the electrolyte and product gas ports 210, 215, 220 and 230 of the cell 100 with the guide locators 605, O-rings 620 and elastomer layer 625.

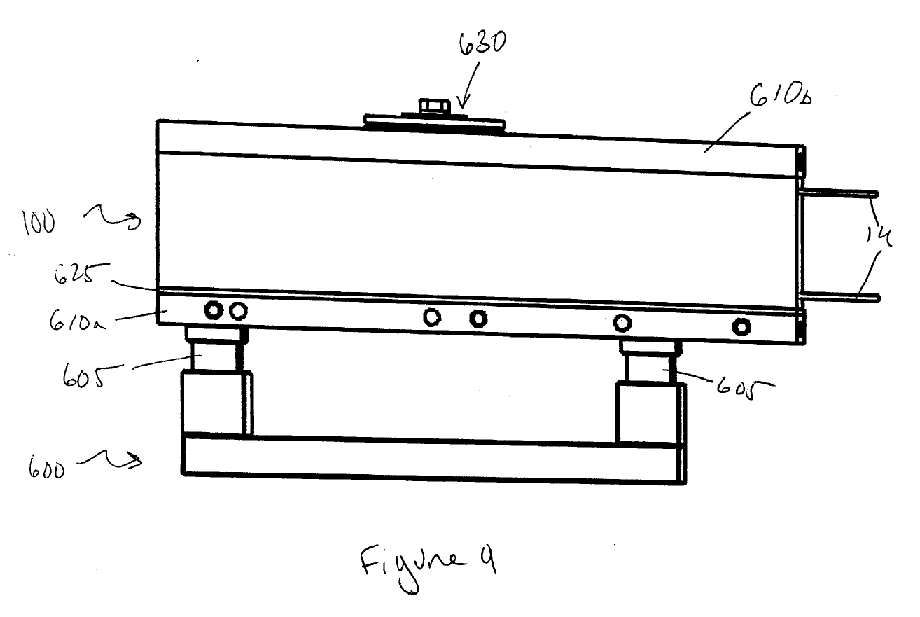

As shown in FIG. 9, a second compression plate 610b may be positioned on the cell 100. A compression member 630, comprising disc springs in the embodiment illustrated, is located on the outside face of the second compression plate 610b.

As illustrated in FIG. 3, an electrolyser 105 according to an embodiment of the invention may be secured by affixing a compression bracket 650 to one of the compression plates 610 (for example plate 610b) and engaging a compression member 630 with a plate 654 of the compression bracket 650 and the other of the compression plates 610 (for example, plate 610a) to apply a compressive force to the cell 100. In the embodiment illustrated, the compression bracket 650 comprises side walls 652 and plate 654 that may be conveniently secured to one of the compression plates 610. In operation the compression member 630 co-operatively engages with the compression bracket to apply a compressive force to the compression plates 610 and accordingly to the cell 100. Conveniently, in the embodiment illustrated, elastomer layer 625 in conjunction with O-rings 620 also provide sealing of the electrolyte and product gas ports 210, 215, 220 and 230 at the cell 100 and compression plate 610 interface.

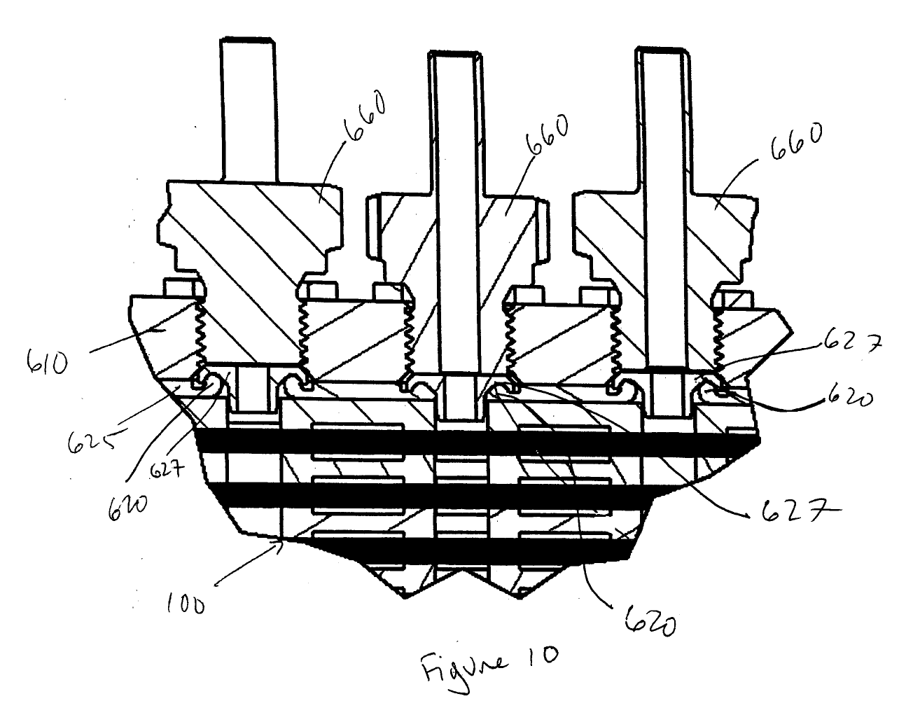

FIG. 10 shows how a port connector 660 may preferably be connected to communicate with the electrolyte and product gas ports 210, 215, 220 and 230, by threading into threaded apertures 615 in compression plate 610 to provide a fluid fitting.

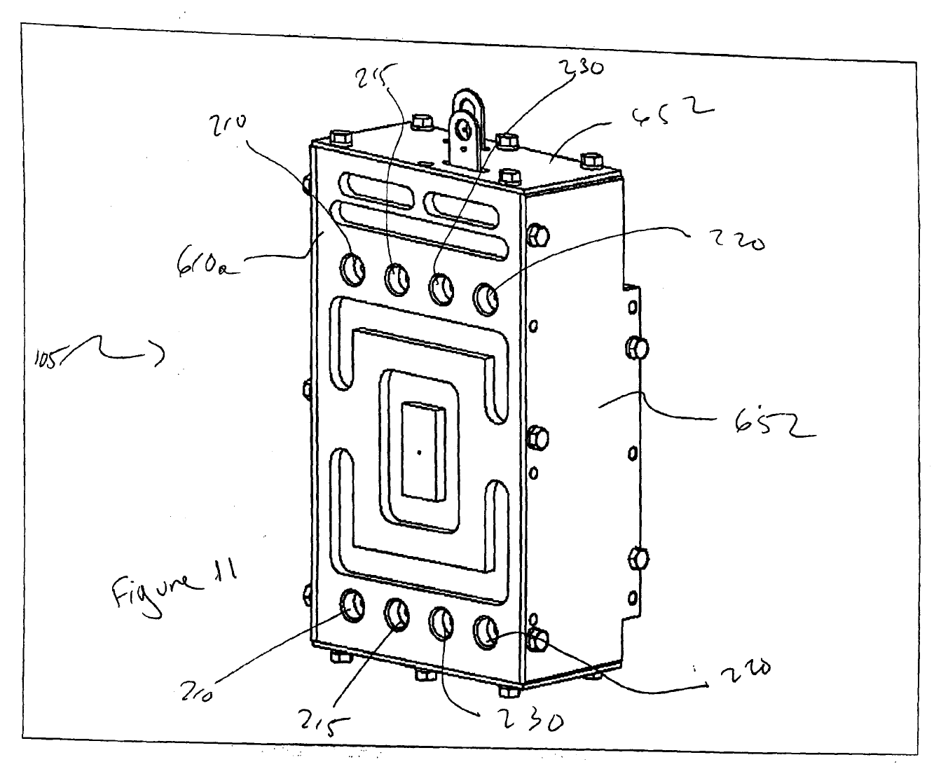

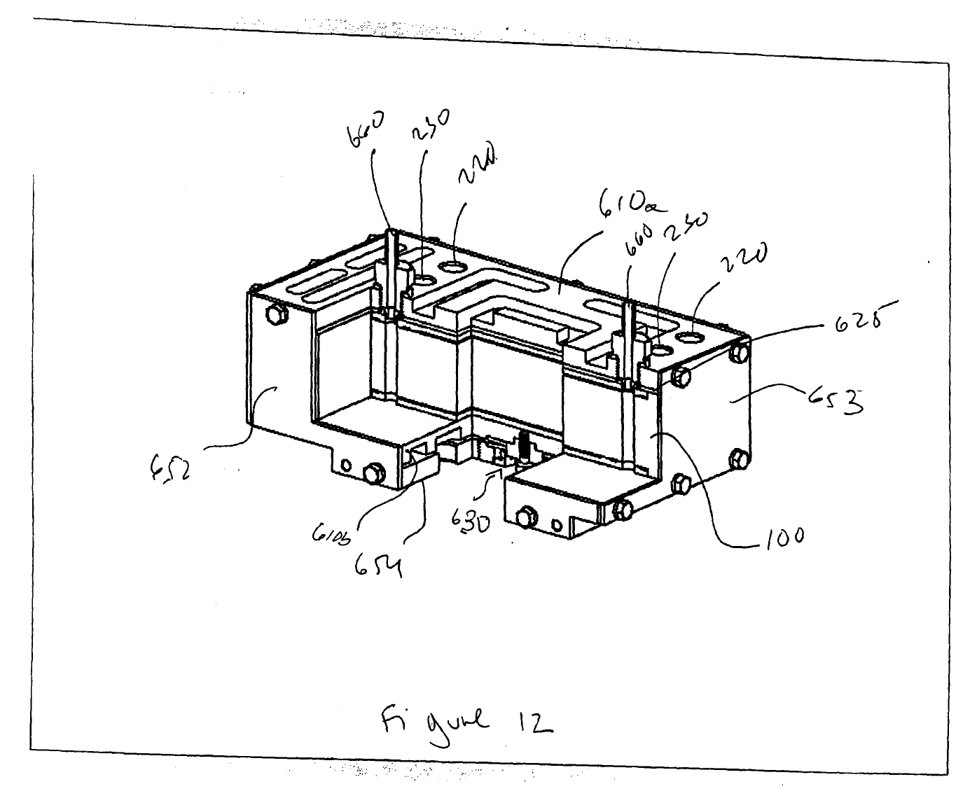

FIG. 11 shows an assembled electrolyser 105. FIG. 12 shows details of the assembled electrolyser 105 with two port connectors 660 in place.

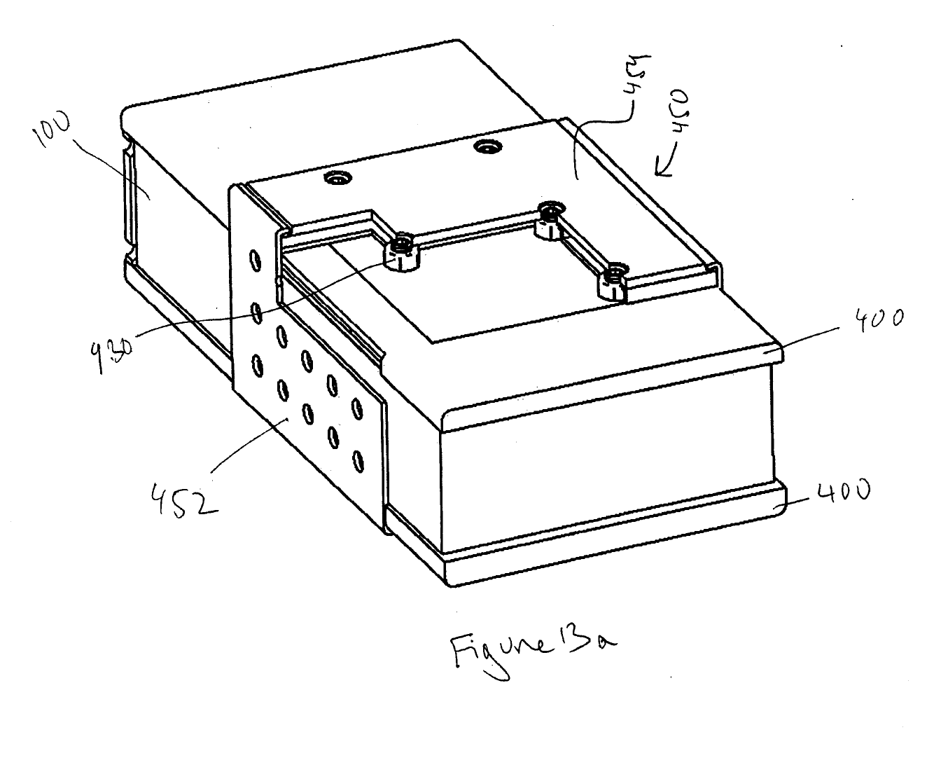

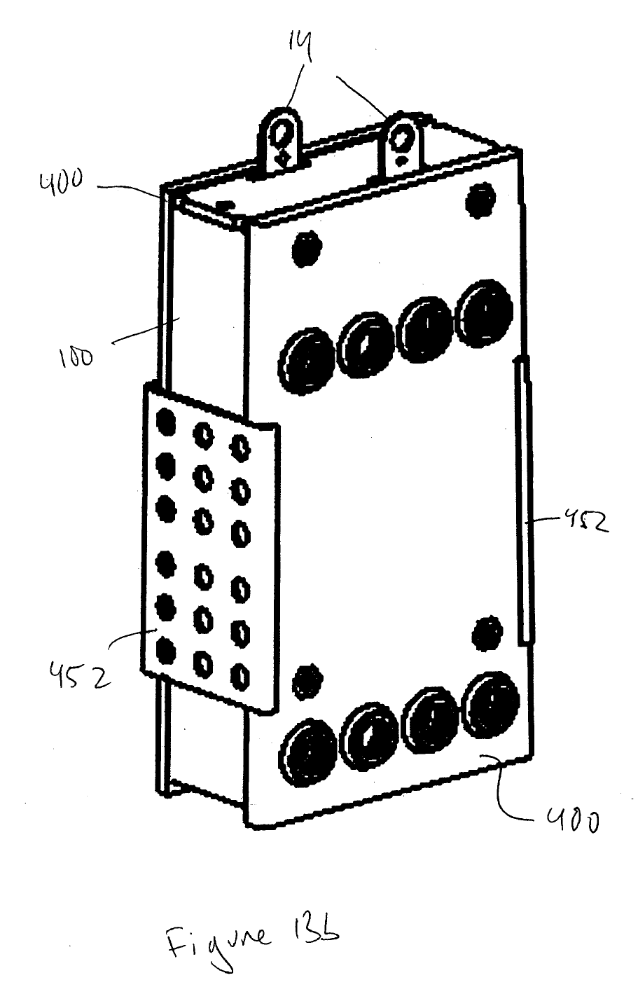

In an alternate embodiment depicted in FIGS. 13a and 13b, a compression bracket 450 is positioned to engage a first compression plate 400 and a compression member 430, comprised of a threaded element in the embodiment illustrated, engaging a second compression plate 400 and the back plate 454 of the compression bracket 450. As mentioned above, the compression member 430 may comprise other known members for applying compression including, the spring properties of the compression bracket 450 itself, as well as a separate bias such as springs, levers or other means.

The compression plates 400 illustrated in the embodiment of FIGS. 13a and 13b may be constructed of a relatively rigid retainer plate 420 surrounded by an elastomer layer 440. The elastomer layer 440 provides both sealing of the ports into the cell as well as to accommodate thermal expansion of the cell 100 with changes in temperature.

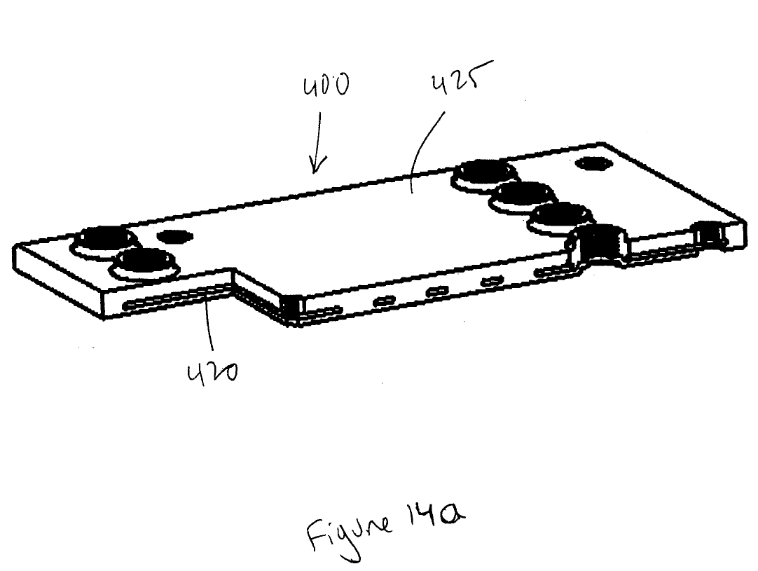

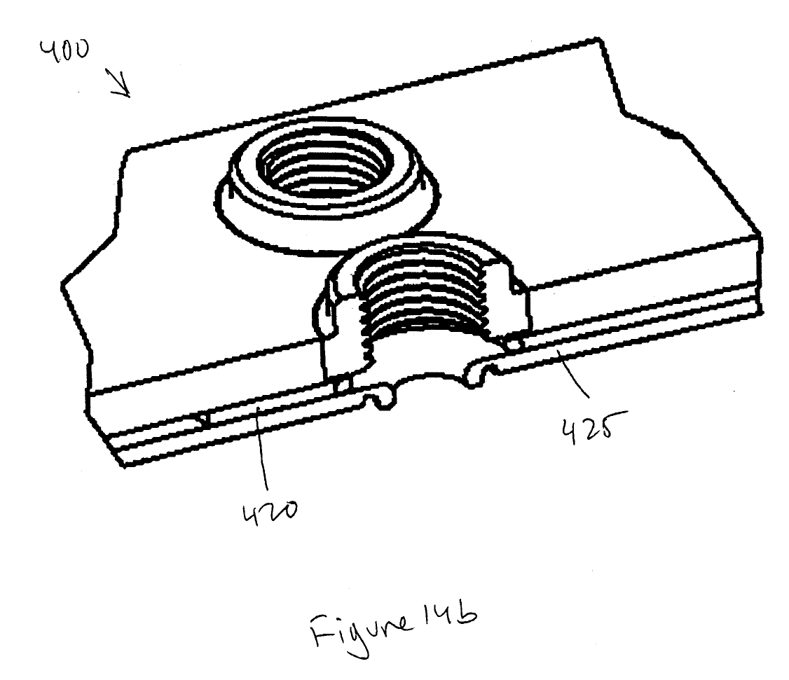

In a preferred embodiment illustrated in FIGS. 14a and 14b, the compression plates 400 comprise a retainer plate 420, preferably composed at least in part of stainless steel and encased in an elastomer layer 425, preferably composed at least in part of Ethylene Propylene Dieene Monomer (EPDM). The elastomer layer 440 is preferably of substantially uniform thickness on each of the stack side face 405 and end side face 410, though the thickness of each side may differ. Preferably the retainer plates 420 include threading female threads to provide a connection for connectors to the cell 100.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. An electrolyser comprising a stack of electrolysis plates, the plates being maintained in substantial alignment to comprise an electrolysis cell, and a press for applying a compressive force transversely to opposed ends of the cell whereby the press maintains the electrolysis plates in substantial alignment when the electrolyser is in operation.

2. The electrolyser of claim 1 wherein the press comprises a first compression plate for locating at one end of the cell and a second compression plate for locating at the opposed end of the cell and a compression member for acting on the first and second compression plates to apply a compressive force to the cell.

3. The electrolyser of claim 2 further comprising at least one elastomer layer to be positioned between the compression plates and the electrolysis cell.

4. The electrolyser of claim 3 wherein the compression plates are composed at least in part of stainless steel.

5. The electrolyser of claim 3 wherein the elastomer is composed at least in part of Ethylene Propylene Dieene Monomer.

6. The electrolyser of claim 3 wherein at least one compression plate has holes that align with ports in the stack of electrolysis plates to allow fluid communication with an interior of the electrolyser.

7. The electrolyser of claim 6 wherein the at least one compression plate further comprises at least one coupling in communication with the holes to connect a fluid fitting in fluid communication to each of the ports.

8. The electrolyser of claim 7 wherein the at least one coupling comprises a female thread.

9. The assembly of claim 8 wherein the at least one coupling comprises at least one nut fixed to the at least one compression plate.

10. The electrolyser of claim 1 wherein one of the compression plates comprises a wall of a container for housing the stack of electrolysis plates.

11. The electrolyser of claim 1 wherein the electrolysis plates are maintained in alignment by a layer of a sealant.

12. The electrolyser of claim 7 wherein an O-ring is disposed about the coupling.

13. The electrolyser of claim 12 wherein the O-ring forms part of the elastomer layer.

14. A method of stabilising an electrolyser comprising a stack of electrolysis plates, the electrolysis plates being maintained in substantial alignment, the method comprising
locating the stack of electrolysis plates between compression plates of a press; and
applying a compressive force with the press to the stack of electrolysis plates to maintain the electrolysis plates in substantial alignment when the electrolyser is in operation.

15. The method of claim 14 wherein the stack of electrolysis plates are maintained in alignment by a layer of a sealant.

16. The method of claim 14 further comprising the step of locating at least one elastomer layer between the compression plates and the stack of electrolysis plates to provide accommodation for changes in a volume of the electrolyser.

17. The method of claim 16 further comprising the step of locating a second elastomer layer between the compression plates and the stack of electrolysis plates to provide accommodation for changes in the volume.

18. The method of claim 16 further comprising providing an O-ring about each of one or more ports in the stack of electrolysis plates, the ports allowing fluid communication with an interior of the electrolyser.

19. The method of claim 18 wherein the O-ring about each of the one or more ports forms part of the elastomer layer.

20. The method of claim 16 further comprising the step of locating an insert to maintain the O-ring about each of the one or more ports in alignment with each of the one or more ports during assembly.

21. A method of assembling an electrolysis cell using a fixture having assembly guides for positioning elements of the cell and inserts for aligning O-rings with ports in the cell, the method comprising,
positioning a first compression plate on the assembly guides;
the first compression plate having holes to be aligned with the ports in the cell;
positioning the inserts to align the O-rings with the ports in the cell;
positioning the O-rings on the inserts;
positioning the cell on the O-rings;
positioning a second compression plate on the cell; and,
applying a compressive force to the cell by engaging a compression member with the compression plates.

22. The method of claim 21 further comprising positioning an elastomer layer between the cell and the compression plates.

23. The method of claim 22 wherein the O-rings form part of the elastomer layer and the elastomer layer is positioned on the inserts to position the O-rings.

24. The method of claim 22 further comprising positioning a second elastomer layer between the cell and the compression plates.

25. The method of claim 21 further comprising coupling a fluid fitting to each of the holes in the first compression plate.
